(19) United States
(12) Patent Application Publication
(10) Pub. No.: US 2005/0090225 A1
(43) Pub. Date: Apr. 28, 2005

(54) A Simplified Second Generation Enhanced Emergency Communications System SSGE-911

(75) Inventors: Thomas Carl Muehleisen, Greenville, SC (US); Scott Thomas Muehleisen, Ravenna, OH (US)

Correspondence Address: OM2 Technology Inc., 451 W. Riddle Ave., Ravenna, OH, 44266, US

(73) Assignee: OM2 TECHNOLOGY INC., Ravenna, OH (US)

(21) Appl. No.: 10/904,557

(22) Filed: Nov. 16, 2004

(51) Int. Cl. H04M 11/04

(52) U.S. Cl. 455/404.1

(57) ABSTRACT

The present invention provides a standard network system, method and apparatus for processing and routing an emergency request or call (911) and its associated location information, including GPS location information where available, from a traditional telephone device, a wireless device (Cell telephone) or voice over IP (VoIP) device. When an emergency call is detected by a Communications Service Provider (CSP) such as a Telephone Company, VOIP Service provider, Wireless Service Provider, or Originating Caller, the calling party's telephone number or identifying network address is forwarded to the CSP's Service Location Identification System (SLIS) located with and connected to the CSP's communications network. The SLIS will receive from the CSP's network call processing or switching system, the caller's telephone number (ANI) or identifying network address (INA) such as an IP address, MAC address, SIP address, or any such unique identifier of a caller. This number or address is used as the primary search key into the SLIS database where the CSP has previously stored an address location record describing the physical location of the caller associated with the ANI, INA, or network element through which a call is processed that identifies the nearest network device to the caller. Once the SLS has retrieved the caller's nearest location information from its database the caller's voice and that location data, which may include Name, Address, Geographic Coordinates or any other type of location information available, is formatted into XML or the current data exchange mechanism and sent over a network connection to an Emergency Services Responding Service Provider (ESRP). This network may be a private or public IP, SS7 or any other type of network capable of conveying the ANI, INA and the associated location information to a Service Location Receiving System (SLRS) located with and connected to a county or city PSAP or some other type of ESRP.

The present invention relates generally to the field of communications and, more particularly, to standard process and method through which all current and future communications systems may interface by means of a standard interface to an Emergency Services Responding Service Provider, PSAP or other common response point or 911 system.

### SUMMARY OF THE INVENTION

This invention provides a standard network system, method and apparatus for processing and routing an emergency request or call (911) and its associated location information, including GPS location information where available, from a traditional telephone device, a wireless device (Cell telephone) or voice over IP (VoIP) device.

### DETAILED DESCRIPTION OF THE INVENTION

This invention consists of two computer systems, one called a Service Location Identification System located at a Communications Service Provider the other called a Service Location Receiving System located with an Emergency Services Responding Service Provider such as a 911 PSAP. This invention provides a standard network system, method and apparatus for processing and routing an emergency request or call (911) and its associated location information, including GPS location information where available, from a traditional telephone device, a wireless device (Cell telephone) or voice over IP (VoIP) device. When an emergency call is detected by a Communications Service Provider such as a Telephone Company, VoIP Service provider, Wireless Service Provider, or even the Call Originator in some instances, the calling party's telephone number or identifying network address is forwarded to the Communications Service Provider's Service Location Identification System located with and connected to the Communications Service Provider's communications network.

The Service Location Identification System will receive from the Communications Service Provider's network, call processing or switching system, an emergency caller's telephone number (ANI) or identifying network address (INA) such as an IP address, MAC address, SIP address, or any such unique identifier of a caller. This number or address is used as the primary search key into the Service Location Identification System database where the Communications Service Provider has previously stored an address or location record describing the physical location of the caller associated with the ANI, INA or network element through which a call is processed that identifies the nearest network device to the caller.

The Service Location Identification System retrieves the caller's nearest location information from its database and pushes the caller's voice and location data, which may include Name, Address, Geographic Coordinates or any other type of location information available, formatted into XML or the current data exchange mechanism and sent over a network connection to an Emergency Services Provider The network may be a private or public IP, SS7 or any other type of network capable of conveying the ANI, INA and the associated location information to a Service Location Receiving System located with and connected to a county or city PSAP or some other type of Emergency Services Provider.

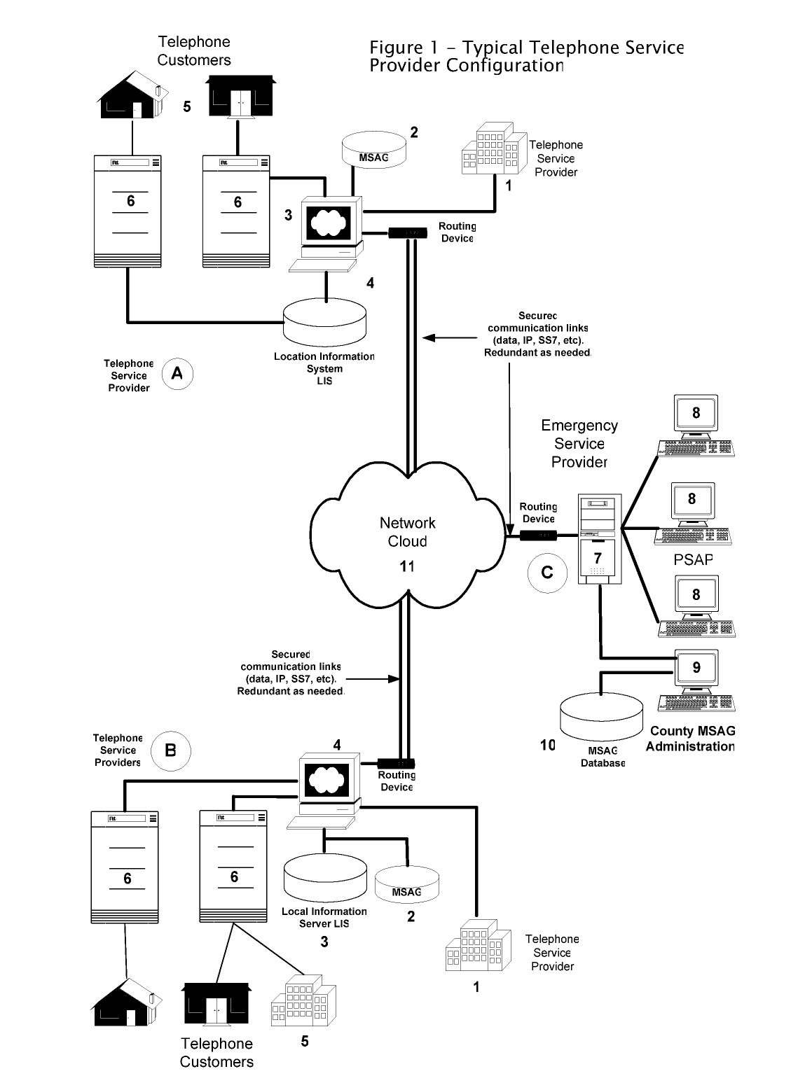

Telephone Service Provider Emergency Call Flow—See FIG. 1

Telephone Service Provider (1) receives an order to provide service. Name address and location information are loaded into the Service Provider's Location Identification Server (3). Each record is compared with the Master Street Address Guide (MSAG) data for valid address spelling and abbreviations (2). Invalid or misspelled address records are designated with a descriptive error code for resolution by the Telephone Service Provider.

When a call from a telephone customer (5) is determined to be a 911 or emergency call the call is identified by the Telephone Service Provider's Central Office or other switching system (6) and routed to the Location Identification System.

The Location Identification System retrieves the customer record and the Identifying Network Address from its database (4) and forwards the caller's voice and location information to the MSAG assigned Emergency Services Responding Agencies (C) Location Receiving System (7) over the interconnecting network (11) where the caller's name, address and other location information is displayed on the Emergency Services Call Takers (8) screen and the caller's voice is connected to the Call Taker's telephone set.

In all towns, city and county jurisdictions street names are added, changed and removed. As these changes occur the jurisdiction's addressing department (9) makes the necessary changes to the Master Street Guide database (10). These changes are uploaded to all Service Provider's Location Identification Servers connected to the interconnecting network (11) and associated with this jurisdiction. MSAG records contain all of the current data fields as defined in the National Emergency Number Association (NENA) data exchange document NENA 02-010 and include an additional field that defines the Identifying Network Address of the responsible jurisdiction.

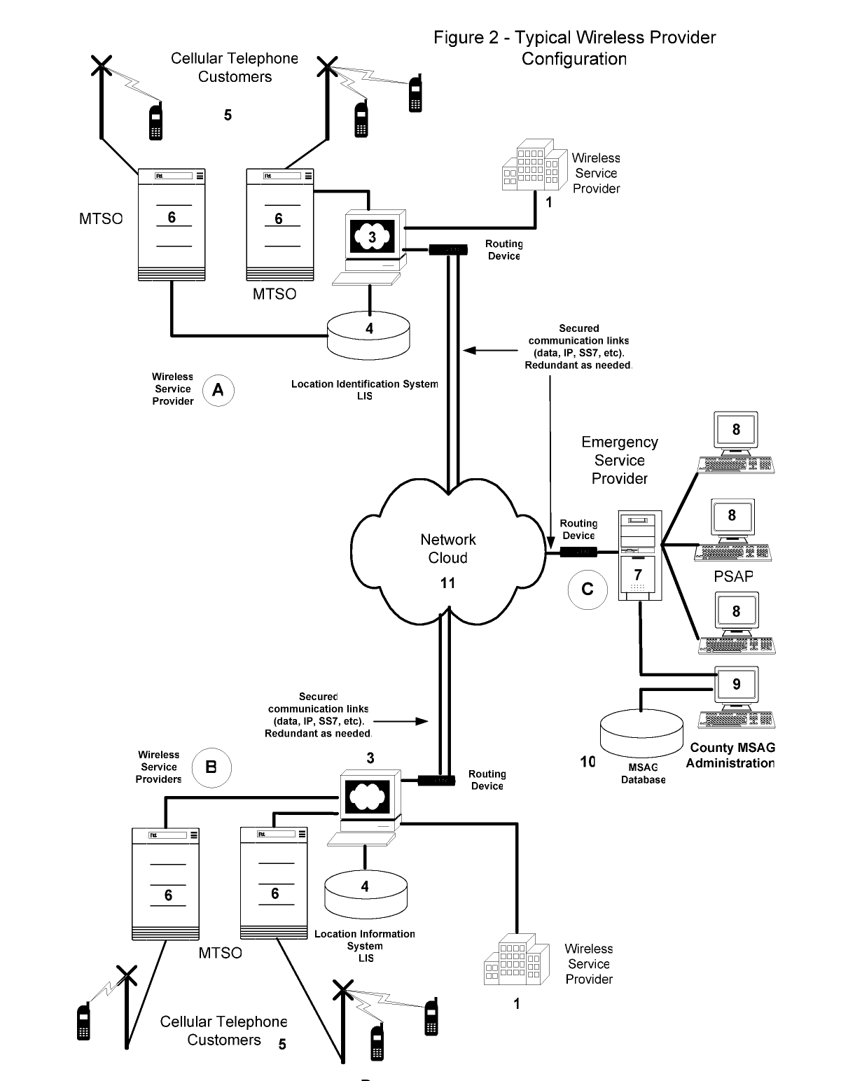

Wireless Service Provider Emergency Call Flow—See FIG. 2

Wireless Service Provider (1) receives an order to provide service. Name address and telephone number are loaded into the Service Provider's Location Identification Server (3).

When a call from a Wireless customer (5) is determined to be a 911 or emergency call the call is identified by the Wireless Service Provider's MTSO or other switching system (6) and routed to the Location Identification System along with the callers voice and current geographic coordinates.

If the caller is in their local Wireless Service Provider's network the Location Identification System (3) retrieves the customer record and determines the Identifying Network Address of the Emergency Services Responding Agency from the geographic coordinates and its database (4). The call and data are then forwarded to the assigned Emergency Services Responding Agencies (C) Location Receiving System (7) over the interconnecting network (11) where the caller's name and other location information is displayed on the Emergency Services Call Takers (8) display and the caller's voice is connected to the Call Taker's Telephone set.

Where the Wireless customer calling 911 is not in their Wireless Service Provider's network the Location Identification System determines the Identifying Network Address of the Emergency Services Responding Agency from the geographic coordinates and its database (4). The caller's voice and data are then forwarded to the assigned Emergency Services Responding Agencies (C) Location Receiving System (7) over the interconnecting network (11) where the caller's current location information is displayed on the Emergency Services Call Takers (8) display and the caller's voice is connected to the Call Taker's Telephone set.

The Emergency Services Call Taker may request an update to the caller's geographic position buy sending a request for refresh back through the interconnecting network (11) to the MTSO or other switching system (6).

In all towns, city and county jurisdictions geographic ranges and polygons are created, maintained and stored in the Emergency Service Provider's MSAG Administration System. As these changes occur the jurisdiction's addressing department (9) makes the necessary changes to the Master Street Guide Administration database (10). These changes are uploaded to all Wireless Service Provider's Location Identification Servers connected to the interconnecting network (11) and associated with this jurisdiction. These geographic references are associated with the Identifying Network Address of the responsible jurisdiction. When a 911 or other emergency call occurs on the Wireless Provider's network the geographic coordinates provided by the MTSO or other switching system (6) are used to determine the Identifying Network Address of the responsible jurisdiction for this call and the caller's voice, coordinates and any other available data such as Automatic Collision Notification (ACN) or medical date are sent to the jurisdiction.

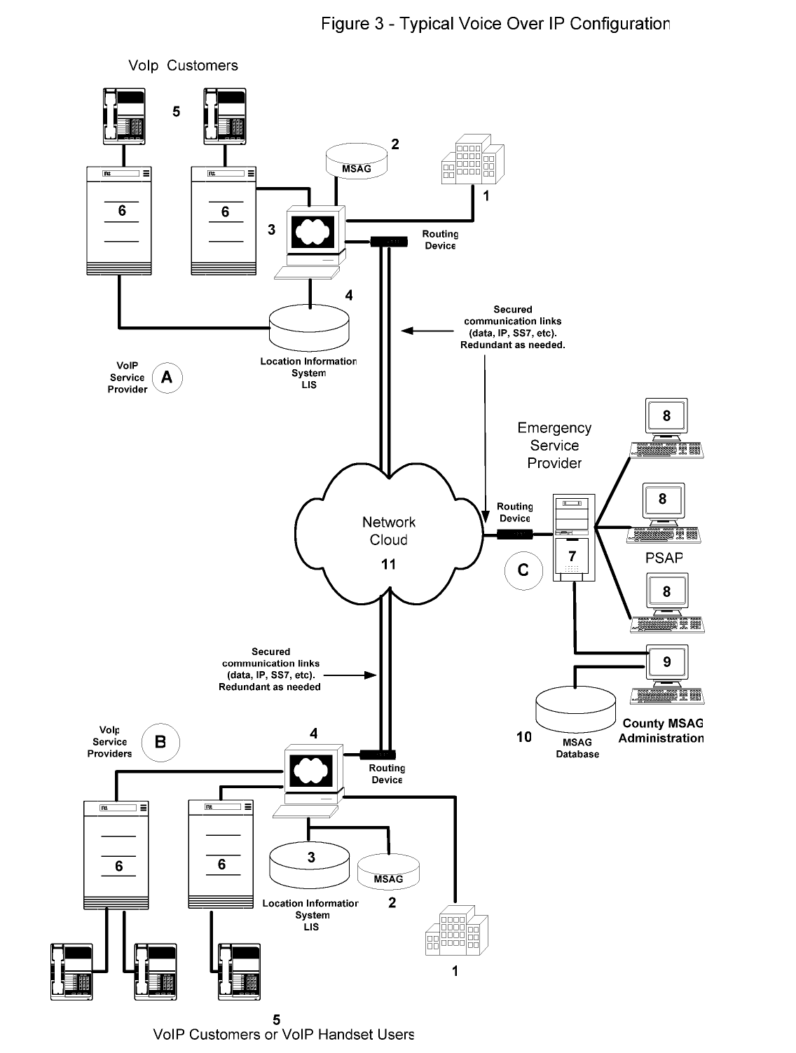

VoIP Service Provider Emergency Call Flow—See FIG. 3

VoIP Service Provider (1) receives an order to provide service. Name address and location information are loaded into the Service Provider's Location Identification Server (3). Each record is compared with the Master Street Address Guide (MSAG) data for valid address spelling and abbreviations (2). Invalid or misspelled address records are designated with a descriptive error code for resolution by the VoIP Service Provider.

When a call from a VoIP customer or VoIP handset user (5) is determined to be a 911 or emergency call the call is identified by the VoIP Service Provider's switching system (6) and it is routed to the Location Identification System.

The Location Identification System retrieves the customer record and the Identifying Network Address from its database (4) and forwards the caller's voice and location information to the MSAG assigned Emergency Services Responding Agency's (C) Location Receiving System (7) over the interconnecting network (11) where the caller's name, address and other location information is displayed on the Emergency Services Call Takers (8) display and the caller's voice is connected to the Call Taker's Telephone set.

In all towns, city and county jurisdictions street names are added, changed and removed. As these changes occur the jurisdiction's addressing department (9) makes the necessary changes to the Master Street Guide database (10). These changes are uploaded to all Service Provider's Location Identification Servers connected to the interconnecting network (11) and associated with this jurisdiction. MSAG records contain all of the current data fields as defined in the National Emergency Number Association (NENA) data exchange document NENA 02-010 and include an additional field that defines the Identifying Network Address of the responsible jurisdiction.

1. A method for initiating an emergency communication request between a Communications Service Provider, conventional telephone service, wireless cellular service, VoIP, systems capable of communicating global positioning data using the Global Positioning Systems capability, or similar type communications service, using dedicated data, Internet Protocol, SS7 or any other communications network medium capable of simultaneous communication of a caller's voice and location information, and Emergency Services Responding Service Provider, PSAP or other common point for coordinating a response to an emergency communication.

2. The method comprising the steps of: receiving an emergency call from a Communications Service Provider's network switching element or device connected to a Service Location Identification System, passing a unique identifying key such as telephone number, IP address, MAC address, SIP address, or other unique identifier to the Service Location Identification System, steps of associating the unique identifying key with previously stored customer location information or real time GPS location information, steps of transmitting the unique identifying key along with its location information and callers two way voice communication to a Service Location Receiving System associated with an Emergency Services Responding Service Provider, PSAP or other common response point associated with the caller's location information or current geographic coordinates for the purpose of coordinating a response to an emergency situation or communication. The steps by which the Service Location Receiving System interfaces to or acts as an Emergency Responding Service Provider's PSAP system or other telecommunications system and associated information display system.

3. The method of creating, maintaining and direct distribution of Master Street Address Guide records for physical address validation direct to each Communications Service Provider associated with the Emergency Services Responding Service Provider, PSAP or other common response point.

4. The method of identifying and directly communicating a No Record Found event directly to the Communications Service Provider from which an emergency call or communication has been received.

5. The method of identifying and directly communicating an address or location information error event directly to the Communications Service Provider from which an emergency call or communication has been received.

6. The method of receiving Customer Service Order transactions into a Communications Service Provider's Service Location Identification System, validating and storing individual Customer Service Order location information along with it's unique key in the Service Provider's Service Location Identification System database.

7. The method of receiving the unique key, during an emergency situation, communication or call, into the Communications Service Provider's Service Location Identification System, querying that systems database for an associated customer location information record and sending that record to the associated Service Location Receiving System.

8. The method of identifying and connecting to the assigned Emergency Services Responding Service Provider, PSAP or other common response point by way of the dedicated data, Internet Protocol, SS7 or any other communications network medium.

9. The method of simultaneously transmitting or pushing an emergency caller's voice, unique key and location information directly from the Communications Service Provider's Service Location Identification System to the Emergency Services Responding Service Provider's Service Location Receiving System.

10. The method for a Communications Service Provider to accurately simulate an emergency call through the Service Location Identification System for the purpose of verifying the location information and routing without interfering with the Emergency Services Provider.

11. The method of supporting changes in the Call Originator's location in real-time through the Service Location Identification System.
